(19) United States
(12) Patent Application Publication
(10) Pub. No.: US 2013/0207812 A1
(43) Pub. Date: Aug. 15, 2013

(54) Method and Device for Optical Alert Recognition

(71) Applicant: Michael Heydlauf, Raleigh, NC (US)

(72) Inventor: Michael Heydlauf, Raleigh, NC (US)

(73) Assignee: Siemens Healthcare Diagnostics Inc., Tarrytown, NY (US)

(21) Appl. No.: 13/816,973

(22) PCT Filed: Aug. 15, 2011
(86) PCT No.: PCT/US11/47737

§ 371 Date: May 1, 2013

Related U.S. Application Data
(60) Provisional application No. 61/373,889, filed on Aug. 16, 2010.

(51) Int. Cl. G08B 5/00

(52) U.S. Cl. CPC G08B 5/00
USPC 340/691.6

(57) ABSTRACT

A method for remotely displaying an error state of a controller or an assay testing instrument via a network. The method includes generating and transmitting display image data representing the operating status of the controller; receiving the display image data transmitted by the controller at a remote monitoring unit; displaying the display image data on a display device; comparing high resolution display image data to alert (error) image data stored in a database; and generating an error alert message indicative of the error state when any of the display images matches one of the error alert image.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The field of the invention is related to real-time or pseudo-real-time remote monitoring of error occurrences and/or consumable inventory status of a plurality of assay testing instruments and, more specifically, to remote monitoring of assay testing instruments of varied manufacture and having manufacturer-specific protocols, proprietary software and applications.

International Application Publication Number WO 2009/085534 to the present inventor (“Heydlauf”) discloses an automated, multiple-process assay system for testing and transporting vessels containing samples of biological fluids and the like. The system includes assay testing instruments for performing discrete tests on samples according to pre-established protocols, and plural conveyor mechanisms for transporting the vessels through various sequences, from one testing instrument to another testing instrument.

Each of the monitored assay testing instruments includes an associated controller that is generally, but not necessarily, located proximate to the associated monitored assay testing instrument. Many instrument controllers are adapted to transmit local controller display images to a remote location. Local controller display images graphically represent data, parameters, and status and inventory information concerning the operation of the respective monitored assay testing instrument.

The multiple-process assay system, further, includes at least one remote monitoring unit having a processor and a display device, e.g., a monitor screen. The remote monitoring unit is in communication with the controllers via a communication network. The remote monitoring unit is adapted to enable a single user to monitor the operating and alert status of and to control the operation of the controllers and, thereby, of their associated assay testing instrument from a single, remote location.

With many controllers (“conforming controllers”), an I2I (“instrument-to-informatics”) protocol enables the associated controller of a monitored assay testing instrument to transmit error occurrence data and/or consumable inventory status data to the remote monitoring unit. The remote monitoring unit's processor uses such data to provide a visual, auditory, and/or electronic alert message, alerting the user of an error state, e.g., of the need to replenish dwindling consumable articles, of expiry of a reagent batch, of a need for scheduled maintenance or unscheduled repairs, and the like.

A problem arises, however, if the monitored assay testing instruments are marketed by different manufacturers, which use proprietary software or manufacturer-specific protocols. Thus, in a larger laboratory setting, the associated controller of one or more of the monitored assay testing instruments, which is to say, a “non-conforming controller”, is not programmed to transmit or otherwise is incapable of transmitting error occurrence data and/or consumable inventory status data to the remote monitoring unit in a useable format that can be read by or is compatible with the remote monitoring unit. Accordingly, it would be desirable for remote monitoring units to create an automatic visual, auditory, and/or electronic alert message(s) for non-conforming controllers and their corresponding assay testing instrument, to alert the user of the time and location of the occurrence error, of the need to replenish dwindling consumable articles at a discrete monitored assay testing instrument, and the like, even though the controller of one or more of the monitored assay testing instruments is not programmed to transmit error occurrence data and/or consumable inventory status data in a form that is readable by or compatible with the processing unit of the remote monitoring unit.

### BRIEF SUMMARY OF THE INVENTION

A method of, diagnostic software for, and a laboratory process manager capable of providing a visual, auditory, and/or electronic alert message(s) to a user monitoring a plurality of assay testing instruments or any computer or processing device using a remote monitoring unit are disclosed. The method, diagnostic software, and laboratory process manager use display data that are transmitted by controllers associated with the assay testing instruments to the remote monitoring unit at the remote monitoring site via RFB (remote frame buffer) protocol, which is well known to those of ordinary skill in the art.

More specifically, a method for remotely displaying an error state of an assay testing instrument or any processing device or controller via a network is disclosed. The method includes generating and transmitting display images representing the operating status of the controller associated with an assay testing instrument; receiving the display images transmitted by each of the plurality of controllers at a remote monitoring unit; displaying the display images on a display device;

comparing each display image to an alert (error) image(s) stored in a database therefor; and transmitting an alert (error) message indicative of the error state when any of the display images matches an alert (error) image. The method further includes displaying the alert (error) message on the display device, e.g., as a static or a dynamic alert (error) flag or message window that is coupled to an image of the discrete assay testing instrument shown on the display device. When none of the display images matches the error alert image(s), the method includes determining whether or not the display image denotes an error state in the assay testing instrument; creating a new alert (error) image that is identical or substantially identical to the discrete display image for each of the display images that denotes an error state; and storing the new alert (error) image in the database therefor.

First and second comparison region can be designated within the display image of an error state. Optical character recognition (OCR) can be performed on the data within the second comparison region.

### BRIEF DESCRIPTION OF THE SEVERAL VIEWS OF THE DRAWINGS

The invention will be more fully understood by reference to the following Detailed Description of the Invention in conjunction with the Drawing, of which:

FIG. 1 is an illustrative isometric, display screen image of a specific zone in a laboratory in accordance with the present invention;

FIG. 2 is a flow chart of a method for creating an error image recognition rule and for transmitting an alert message when a discrete error image is recognized in accordance with the present invention;

FIG. 3 is an illustrative display screen image in which FIG. 3A shows an exemplary pop-up window for designating first and second regions and for creating an error image recognition rule in accordance with the present invention and FIG. 3B shows an exemplary menu for creating an alert error rule for a discrete alert state;

FIG. 4 is the illustrative display screen image of FIG. 1 further having a potential alert state at one of the assay testing instruments in accordance with the present invention; and

FIG. 5 is the illustrative display screen image FIG. 4 further displaying an alert (error) flag at the assay testing instrument at which an error has occurred.

### DETAILED DESCRIPTION OF THE INVENTION

Specific, illustrative examples embodying the appended claims are described. The examples are illustrative, for purposes of explaining the present invention by describing particular operations in reference to particular examples, thereby enabling those of ordinary skill in the relevant art to understand and practice the invention. The specific examples are not limiting but, rather, are illustrative. As will be understood by those of ordinary skill in the relevant art, upon reading this disclosure, various alternatives embodying the present invention can be readily implemented.

Features described in reference to specific embodiments are not necessarily exclusive to those specific embodiments and may be included in other embodiments.

Functional flow diagrams and their respective blocks are only illustrative logical representations of example operations and, unless otherwise specified, are not limiting as to relative time of acts or functions performed, or to a specific construction or arrangement for performing the functions.

The methods described herein may be provided as a machine-readable medium having stored, machine-readable instructions, or representations of such instructions, enabling an electronic processing machine to perform the described method. The term “machine-readable medium” includes, but is not limited to, solid-state memories, optical and magnetic disks, and any electrical or electromagnetic signal representing information.

International Application Publication Number WO 2009/085534 entitled “Method and Apparatus for remote Multiple-Process Graphical Monitoring” to Heydlauf is incorporated herein in its entirety by reference. In pertinent part, Heydlauf discloses providing “integrated event (‘flag’) management to notify remote users in real-time of a mechanical or inventory problem or potential problem associated with one of the monitored assay systems and/or one of the controllers. For example, flag management can provide pop-up flag images and/or pop-up display windows on the monitor display screen of the remote monitoring unit, to alert remote users of mechanical and/or inventory issues associated with specific controllers and/or monitored assay system. User interaction, e.g., acknowledgement of the flag, with the pop-up flags and/or notices can be recorded electronically to provide actions taken and response times, e.g., for audit purposes. Additionally, the fifth application can include a flag management button, e.g., on a home screen image, that provides data on all flag events, such as time of occurrence, time of acknowledgement, actions taken, and the like. These data can be filtered using a plurality of parameters such as, for example, specific date, specific time, date range, time range, by assay test, by instrument type, by specific instrument, by criticality of flag, and so forth.”

Whereas Heydlauf discloses alert flag management for assay testing instruments that are adapted to generate data for that purpose, the present invention applies to a KVM over-IP device(s) not so adapted but that, instead, uses a dedicated controller and potentially-specialized video capture hardware to capture keyboard, video, and/or mouse signals; to compress and to convert these signals into data packets; and to transmit the compressed and converted data packets over a network, e.g., a local area network (LAN), a wide area network (WAN), a telephone network, an Ethernet link, the Internet, and so forth, to a remote console application. A remote monitoring unit operating the remote console application subsequently unpacks and reconstitutes the dynamic graphical image data. This arrangement allows multiple controllers, which may or may not have an associated monitored assay testing instrument, to be controlled remotely across a LAN, WAN, telephone line, Internet, and the like using designated protocols.

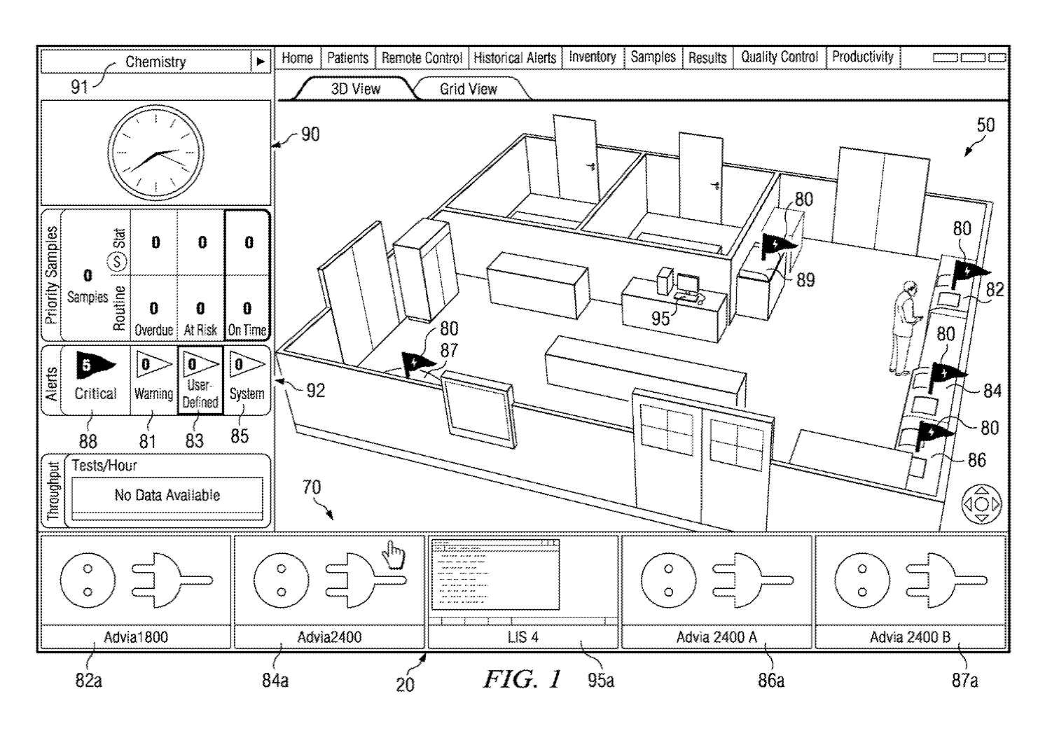

Referring to FIG. 1, an illustrative display screen image 20 at a remote monitoring unit is shown. In pertinent part, the salient features of the monitor screen image 20 includes an isometric, three-dimensional image 50 of a particular zone in a laboratory or work environment, e.g., a “Chemistry” zone 91, a plurality of static or dynamic thumbnail images 70, and a zone dashboard 90. Although the invention will be described such that the image 50 is “virtual”, those of ordinary skill in the art can appreciate that real-time imagery of the laboratory can also be used.

The zone dashboard 90 includes, inter alia, an instrument alert or “flag” summary section 92 that provides an at-a-glance summary of the number and variety of instrument alert flags that have been raised on discrete monitored assay testing instruments disposed in the “Chemistry” zone 91 of the laboratory. Alert flags associated with a discrete assay testing instrument are generated and appear automatically as described in Heydlauf or as described hereinafter as potential or existing errors, consumable resource shortages, and/or other problems or shortcomings associated with the particular instrument in the particular zone occur.

Three varieties of instrument flags are shown in the instrument flag summary section 92 of FIG. 1, to provide visual indicia of the severity or criticality of the error: critical (red) summary flags 88, warning (yellow) summary flags 81, and user-defined (blue) summary flags 83. “Critical flags” refer to those errors that will stop or hinder further testing. “Warning flags” provide advance notice of pending inventory errors as well as of non-critical mechanical problems. “User-defined flags” correspond to user-created or user-defined events that can be associated with a specific instrument. Non-exclusive examples of user-defined flags include scheduled events such as instrument calibration dates, routine or scheduled maintenance dates, and the like.

A fourth flag variety 85 also appears in the zone dashboard 90: a system (orange) summary flag 85 that applies to the system as a whole and to no particular assay testing instrument. For example, if a software update for the system were available, its availability could be reflected using a system summary flag 85.

The numbers shown in the summary flags 81, 83, and 88 of the instrument flag summary section 92 correspond to the number of instrument flags currently raised and displayed in the virtual image 50 of the zone 91 on the monitor screen image 20. No flags will appear in the virtual image 50 for system summary flags 85. According to the illustrative example in FIG. 1, there are a total of five “critical” flags 88, zero “warning” flags 81, and zero “user-defined” flags 83 in the “Chemistry” zone 91. In real terms, this means that within the “Chemistry” zone 91, there are five critical errors or other problems among the assay testing instruments. These critical errors may be manifest on five separate assay testing instruments, on a single instrument or on any combination thereof.

Referring to the virtual image 50 of the zone 91 in FIG. 1, errors, problems, and/or shortcomings are highlighted by instrument flags 80. The errors, problems, and/or shortcomings can include inventory errors, e.g., empty or near empty consumable levels, empty or near empty reagent levels, expired or nearly expired reagent, communication errors, quality control issues, mechanical errors, and/or optical character recognition (OCR) occurrences. After the error, problem, and/or shortcoming has been rectified at a particular assay testing instrument, the corresponding instrument flag 80 automatically disappears and the number appearing in the corresponding instrument flag summary section 92 automatically reflects the change.

The opposite is also true, which is to say that until the error, problem, and/or shortcoming have been resolved the instrument flag 80 will continue to appear and the number appearing in the corresponding instrument flag summary section 92 will reflect all raised instrument flags. Instrument flag management, for managing workflow and providing a means for auditing reaction time and actions taken (and by whom) to resolve errors, is one of the many applications of Heydlauf.

When an instrument flag and/or an alert message window is generated and appears or pops-up in the monitor screen image 20, it can include or be accompanied by a visual warning to alert a remote user of its occurrence. For example, if a color monitor display screen 20 is being used, the color of the instrument flags 80 can correspond to one of the three flag varieties, i.e., red, yellow or blue. Furthermore, a symbol or icon can be included in the instrument flag 80 to indicate the type of alert, viz., whether it is an inventory issue, a mechanical issue, an information issue, and so forth. Although not shown, initial notification of an error associated with an instrument can include a moving or waving instrument flag 80 and/or a blinking asterisk or other symbol (not shown) located in an upper corner of the instrument flag 80. The dynamic, waving motion of the instrument flag 80 and/or the blinking asterisk features can be programmed to continue until a user has acknowledged the instrument flag 80. Once acknowledged, the waving motion of the instrument flag 80 and/or the blinking asterisk will stop; although, the instrument flag 80 itself will continue to be displayed until the cause for the alert has been addressed.

As taught in Heydlauf, “acknowledging” an instrument flag 80 can be performed by clicking or double-clicking on the image of the instrument flag 80 or by clicking or double-clicking on the respective assay testing instrument shown in the virtual image 50 of the zone 91. If acknowledgement does not occur within a pre-established period of time, the processing unit and/or the controllers can be adapted to generate an escalation message. When an error associated with an instrument flag 80 is escalated, for example, a blinking exclamation point (not shown) can be generated and displayed in the virtual image 50, e.g., in an upper corner of the instrument flag 80; the size of the escalated alert flag can be made larger than other, non-escalated instrument flags 80; and so forth.

Additionally, or alternatively, a larger blinking or non-blinking exclamation point (not shown) can also be included in a pop-up message window in the monitor screen image 20, to indicate the escalated status of the unacknowledged alert (error) message. The blinking exclamation points can continue to blink until the user finally acknowledges the respective instrument flag 80. Once acknowledged, the exclamation points can disappear; the size of the instrument flag 80 can return to the standard size; the respective instrument flag 80 will stop waving; and the like.

Even if acknowledged, if the error, problem or shortcoming is not resolved within a predetermined period of time, the processing unit and/or the controllers can be adapted to cause the instrument flag 80 to move or wave again and, if resolution is still not accomplished, the processing unit and/or the controllers can be adapted to generate another escalation message as previously described.

Thumbnail images of each of the assay testing instruments in the zone of the laboratory are shown on the monitor display screen 20 of the remote monitoring unit in real-time or pseudo-real time in a static or dynamic (scrolling) fashion. Real-time imaging refers to the capability of the system to record and transmit images of happenings and events at each monitored assay system continuously and in real-time. Pseudo-real time imaging refers to the capability of the system to detect changes in local imaging at the controller level and to transmit any changes to the remote monitoring unit after detection. Because there is a short lag time between detection and transmission, the thumbnail images would be displayed in pseudo-real time. Pseudo-real time imaging can also refer to the capability of the system to transmit images of happenings and events at each monitored assay testing instrument at a periodic, predetermined time interval, such as a refresh feature on commercially available software and Internet Web sites.

Each of the thumbnail images 82a, 84a, 86a, 87a, and 95a shown in the static or scrolling display 70 corresponds to a discrete assay testing instrument 82, 84, 86, 87, and 95 disposed in the zone of the laboratory corresponding to the virtual image 50. Although in FIG. 1, instrument 89, inter alia, is included in the virtual image 50, a corresponding thumbnail image is not shown in the scrolling display 70 because the dimensions of the monitor display device and monitor display screen 20 are not large enough to display all of the thumbnail images at once, i.e., statically. Hence, the thumbnail images are scrolled across the thumbnail display area dynamically.

Indeed, monitor display screens having relatively larger screen areas, as a rule, can provide a greater screen area to accommodate relatively more and/or relatively larger static thumbnail images than monitor display screens with relatively smaller screen areas. Much of this again depends on the desired quality and detail of the static thumbnail image on the monitor display screen, which are affected, for example, by the number of pixels per static thumbnail image, which can vary from display screen to display screen and from user to user. Some users may be predisposed to include a single horizontal row of static thumbnail images on a monitor display screen while other users may prefer more than one horizontal row of static thumbnail images on the monitor display screen.

For the purpose of this description, it is assumed that instrument 95 in the zone 91 is “non-conforming”, which is to say that, the controller of the assay testing instrument 95 is incapable of providing alert (error) messages to the processing unit of the remote monitoring unit in a language or using a protocol that the processing unit, e.g., the software, of the remote monitoring unit can read, translate or otherwise use. More specifically, the non-conforming assay testing instrument 95, by itself, is incompatible with the previously-described, integrated event flag management.

The processing unit of the remote monitoring unit and/or the controllers of the “conforming” instruments 82, 84, 86, 87, and 89 are adapted to transmit real-time or pseudo-real-time graphical images associated with the respective monitored assay testing instruments for display as a monitor display image 20 on the monitor display screen as long as the monitored assay testing instrument is operating and coupled to the remote monitoring unit via a network. Each of the real-time or pseudo-real-time thumbnail images 82a, 84a, 86a, and 87a displayed as display images 20 on the monitor display screen of the remote monitoring unit is identical to the graphical images being shown locally on the display device associated with the respective controller of the monitored assay testing instrument.

The thumbnail image(s) 95a of the non-conforming instrument(s) 95 shown in the monitor display image 20 on the display device of the remote monitoring unit is substantially similar or identical to the graphical image(s) being shown in real-time or pseudo-real-time on a display device associated with the controller of the non-conforming instrument 95. However, because errors, problems or shortcomings having to do with the non-conforming instrument 95 do not automatically trigger an appropriate alert (flag) message on the display image 20, according to the present invention, an alert (flag) message can still be automatically displayed in accordance with the following method.

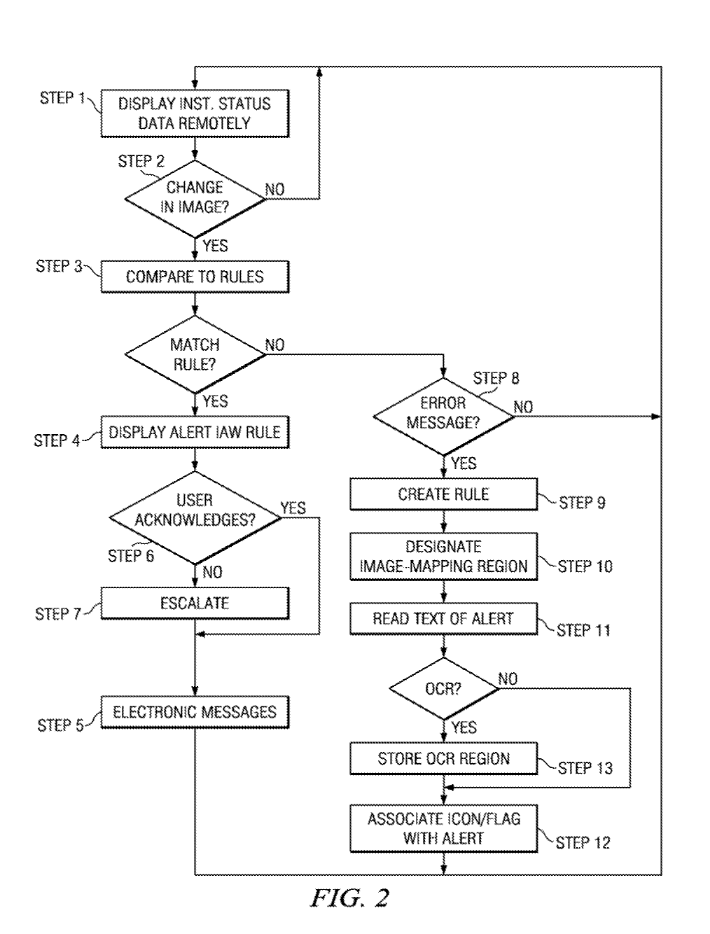

A flow chart describing the functioning of the present invention is shown in FIG. 2. As previously mentioned, thumbnail images of the images shown on local display screens of a plurality of controllers are shown statically or dynamically in real-time or pseudo-real time on a monitor display screen of a remote monitoring unit (STEP 1). This occurs whether or not the assay testing instrument is conforming or non-conforming. The thumbnail images in the display screen image 20 are identical or virtually identical to the graphical images being shown on the local display device associated with the respective controllers of the conforming or non-conforming system. For non-conforming instruments, at least initially and until an error rule image has been created, the thumbnail images 95a must be monitored continuously by an alert user for any changes to the image shown on the monitor display screen (STEP 2).

Only when a change to the graphical thumbnail image 95a on the display screen image 20 occurs are the high resolution data corresponding to the lower resolution graphical thumbnail image 95a compared to one or more error rule images that have been purposely created and stored in a database provided therefor (STEP 3). If the high resolution data corresponding to the thumbnail image 95a match one of the error rule images, then the processing unit of the system causes an alert notification, e.g., a flag, an icon, a message window, and the like, to be displayed on the display screen image 20 according to the pre-established rule associated with the error rule image (STEP 4). Optionally, an auditory alert, an electronic mail message, an electronic page, a cell phone or telephone call, and the like can automatically be sent (STEP 5) in addition to the visual alert notification (STEP 4).

The human user monitoring the monitor display device of the remote monitoring unit will be trained to respond to, i.e., acknowledge, the occurrence and recognition of any alert notification (STEP 6), including notification from a non-conforming instrument. Acknowledgement of the alert notification (STEP 6) can include, for purposes of illustration and not for the purposes of limitation, simply notifying or signaling the system that the user is aware of the alert notification and/or that the cause of the alert notification has been addressed or resolved, e.g., new reagent has been added to the instrument, an expired reagent has been replaced by a fresh reagent, a mechanical malfunction has been repaired, and so forth. If the user does not acknowledge an alert notification prior to expiry of a pre-determined period of time for doing so, the processing unit of the system can be programmed to escalate the alert notification (STEP 7). Escalation (STEP 7) is discussed in greater detail above and in the Heydlauf patent.

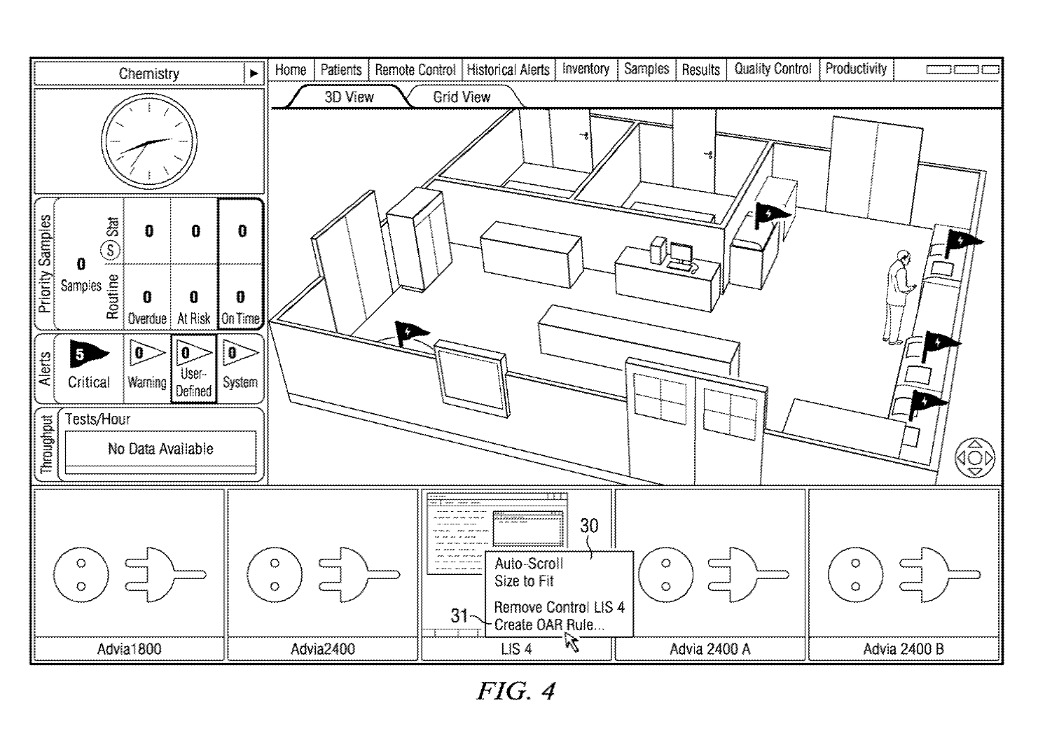

When a change to the displayed image of a non-conforming instrument occurs (STEP 2) the high resolution data corresponding to the thumbnail image 95a are compared to all of the error rule images (STEP 3) that have been previously created and stored in a memory or a database provided for the purpose of such comparisons. If, after a comparison of the high resolution data corresponding to the thumbnail image 95a with the previously created and stored error rule images (STEP 3), the high resolution data corresponding to the thumbnail image 95a do not correspond to any of the previously created and stored error rule images, then a pop-up message window will appear automatically within the display screen image 20, prompting the user whether or not, inter alia, to create a new error rule image. An illustrative pop-up message and menu 30 for creating an error rule image is shown in FIG. 4 and is discussed in greater detail below.

For each occurrence of a change in the remotely-displayed thumbnail image 95a of a non-conforming instrument that does not correspond to previously created and stored error rule images, the user must then determine whether or not the change in the remotely-displayed thumbnail image 95a is due to an error or problem with the corresponding non-conforming instrument (STEP 8) or is due to any reason for which displaying an alert (error) flag on the virtual image 50 of non-conforming instrument 95 would be appropriate.

If the user determines that the change in the remotely-displayed thumbnail image 95a is not due to a mechanical error or other problem with the corresponding non-conforming instrument, then a new error rule image is not created and the processing unit of the system continues to perform remote monitoring of the thumbnail images shown on the monitor display screen 20. Optionally, a separate database or memory can be provided for non-error rule images for use in comparing a change in a thumbnail image 95a of a non-conforming instrument, to preclude the user from having to ascertain that the change to the thumbnail image 95a does not require a new error rule image.

On the other hand, if the change in the displayed thumbnail image(s) 95a is due to an error or problem with the non-conforming instrument, then the user must create an error rule (STEP 9) for the high resolution data corresponding to the discrete image, which is to say that the user must create a new error rule image. The newly created error rule image will, henceforth, be stored with the other error rule images (STEP 13) for comparison with future high resolution data corresponding to the thumbnail images 95a from non-conforming instruments. The user also creates an alert symbol, icon, message window, and the like (STEP 12) to be displayed on the monitor display screen 20 of the remote monitoring unit and attributes that symbol, icon, message window, and the like to the error rule image; so that, whenever subsequent high resolution data corresponding to the thumbnail images 95a match the error rule image, the symbol, icon, message window, and the like will automatically be displayed in the display screen image 20. More particularly, the symbol, icon, message window, and the like attributed to a particular error rule image can be displayed pointing to, referring to or coupled to the corresponding virtual image of the non-conforming instrument 95 in the virtual image 50 of the zone 91.

A method of creating a new error rule image will now be described in greater detail. Referring to FIG. 4, processing unit software associated with the remote monitoring unit will be designed to generate a pop-up menu or message window 30 that includes a variety of action options. For example, the pop-up window menu or message window 30 in FIG. 4 includes an “AUTO SCROLL” function, a “SIZE TO FIT” function, a “REMOTE CONTROL LIS 4” function, and a “CREATE OAR RULE” function. By clicking or double-clicking on the “CREATE OAR RULE” option 31 in the pop-up menu or message window 30, the user signals the processing unit of the remote monitoring unit to create a new error rule image (STEP 9).

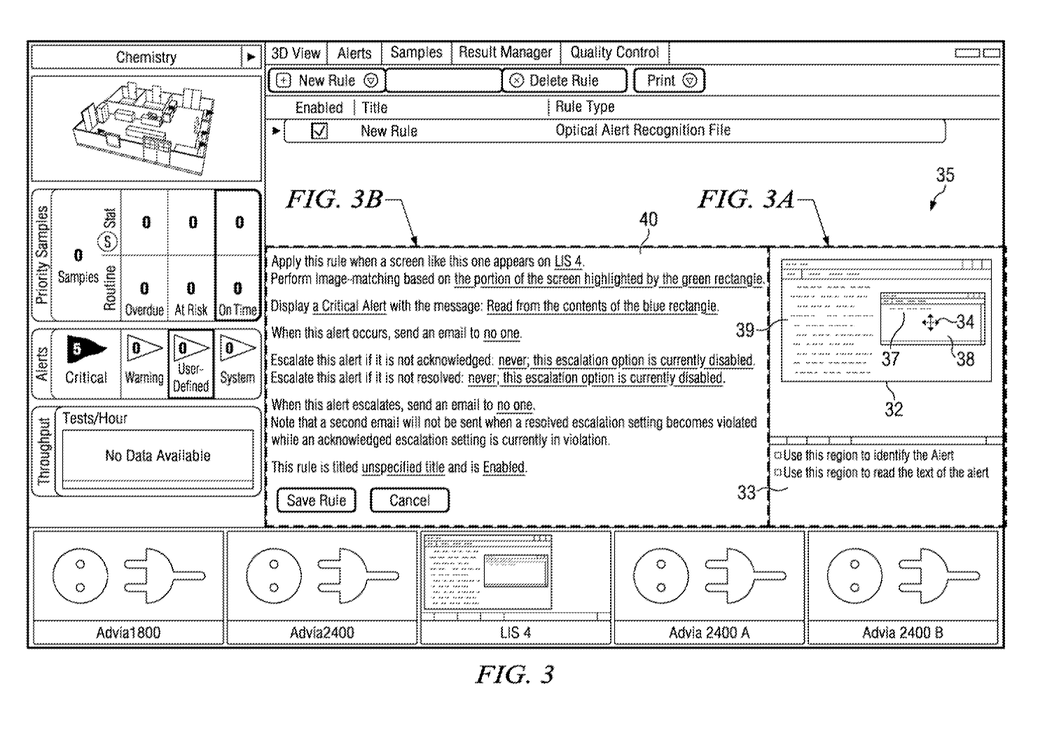

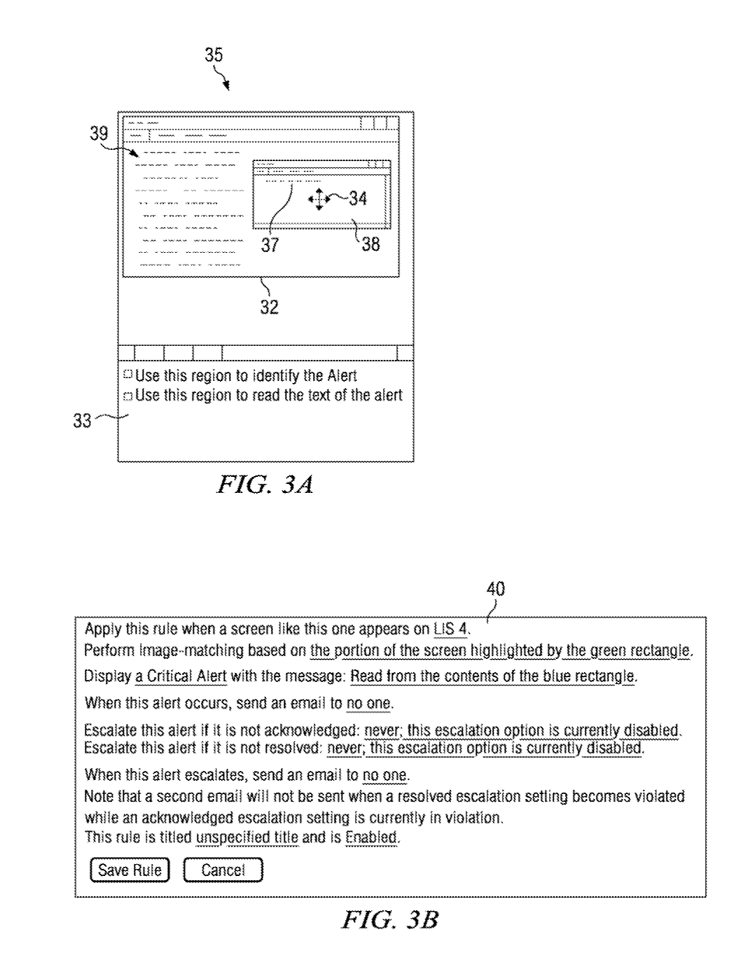

As a result, the processing unit of the remote monitoring unit will, first, create, display, and store an identical or substantially identical digital copy of the display screen image 32 (FIG. 3A) that is shown on the display screen of the controller of the non-conforming instrument at the time of the error message as well as in one of the thumbnail images 95a in a display screen image 20 on the monitor display device of the remote monitoring unit. The digital copy of the display screen image 32 can include a background image 39, e.g., a blue or black screen, and any non-error-related data, as well as an image of the error message box 38 from the display screen image 32 of the display device of the controller of the non-conforming instrument. When the digital screen image 20 is displayed as a pre-rule display screen image 35 on the monitor display screen of the remote monitoring unit, the pre-rule screen image 35 can also include a prompt message box 33 and a movable cursor 34.

The prompt message box 33 enables the user to create an error rule image for the alert and the movable cursor 34 enables the user to highlight, designate or tag a discrete region(s) (STEP 10) on the displayed digital image 32, e.g., the entire image of the error message box 38 or some portion thereof, which can be used for future rule image-matching comparisons (STEP 3).

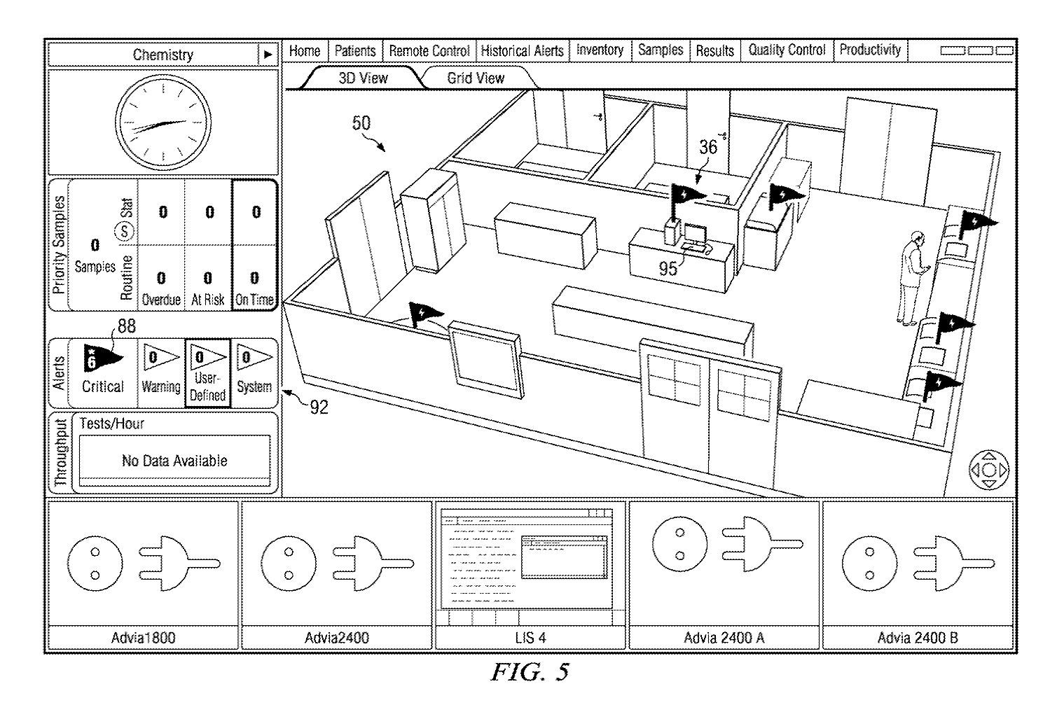

After reading the alert message text 37 contained or written in the image of the error message box 38, the user is able to determine the alert state of the non-conforming instrument 95, which is to say, the nature of the error or problem (STEP 11) in order to create an appropriate alert message whenever another digital image matches the rule image. For example, if the text message 37 in the image of the error message box 38 of the non-conforming instrument 95 mentions approaching an expiration date or expiration time for a reagent being used in the instrument, an appropriate alert message can read “REPLACE REAGENT A”, which will appear automatically (STEP 4). Referring to FIG. 5, an appropriate alert message includes a visual alert icon or symbol, e.g., a flag 36, that appears on the virtual image of the instrument 95 in the zone 50 (STEP 12) on the digital image shown on the display screen of the remote monitoring unit.

To facilitate providing multiple rules for a single non-conforming instrument, the cursor 34 can also be used to designate a second, discrete region 37 within the digital image 32 of the error message box 38, e.g., the original text of the error message or alert state. Data corresponding to the second, discrete region(s) 37 can also be stored in memory provided therefor (STEP 13), for use during image-matching operations. Optical character recognition (OCR) can then be used with data of the second, discrete region(s) to ascertain the specific alert state, e.g., by matching the alert message contained in the second discrete region 37 with the texts of saved images of error messages or alert states.

Referring to FIG. 3B, an illustrative interactive rule setting screen 40 is shown. The rules in the rule setting screen 40 are changeable and govern what series of events occurs once an error message or alert state in connection with a non-conforming instrument 95 that matches a stored error rule image is discovered. For example, the rule setting screen 40 can include at least one of: an identification of the non-conforming instrument 95 involved; an indication as to whether image-matching is based on the first and/or based on the second, discrete region; whether or not electronic messages, e.g., email, pager, text messages, and the like, are to be transmitted and, if so, to which addresses; escalation instructions; and an enable/disable function for the rule.

Optical alert image recognition at the first discrete region levels is not necessarily binary, but rather should allow matching at a 90 to 98 percent probability level.

While certain embodiments and features of the invention have been illustrated and described herein, many modifications, substitutions, changes, and equivalents will occur to those of ordinary skill in the art. It is therefore to be understood that the appended claims are intended to cover all such modifications and changes as fall within the spirit of the invention.

What is claimed is:

1. A method for remotely displaying an error state existing in at least one of a plurality of controllers, each controller being adapted to generate and to transmit display image data representing a status of the controller, the method comprising:
receiving the display image data transmitted by each of the plurality of controllers at a remote monitoring unit;
displaying the display image data transmitted by each of the plurality of controllers on a display device of the remote monitoring unit;
comparing the high resolution data corresponding to the display image data to high resolution data of at least one error alert image stored in a database therefor; and
transmitting an error alert message indicative of an error state at a discrete controller to the remote monitoring unit when any of said high resolution data corresponding to the display image data matches one of the at least one error alert image.

2. The method as recited in claim 1, wherein the display images displayed on the display device of the remote monitoring unit are displayed as thumbnail images.

3. The method as recited in claim 1 further comprising displaying the error alert message on the display device of the remote monitoring unit.

4. The method as recited in claim 3, wherein the error alert message is displayed as a static or a dynamic alert flag or message window that is coupled to an image of the discrete controller on the display device.

5. The method as recited in claim 1, wherein the error alert message includes at least one of a visual alert, an auditory alert, and an electronic message alert.

6. The method as recited in claim 1 further comprising, when none of the display images matches any of the at least one error alert image:
determining whether or not a discrete display image of said transmitted display image data denotes an error state in the respective controller;
creating a new error alert image, whose high resolution image data are identical or substantially identical to the display image data corresponding to the discrete display image that denote an error state; and
storing the high resolution new error alert image data in the database therefor.

7. The method as recited in claim 6, wherein creating the new error alert image includes designating a first comparison region within the discrete display image.

8. The method as recited in claim 7, wherein creating the new error alert image includes designating a second comparison region within the first comparison region.

9. The method as recited in claim 8 further comprising performing optical character recognition of the second comparison region.

10. The method as recited in claim 6, wherein creating the new error alert image includes displaying instructions to resolve the error state at the discrete controller.

11. The method as recited in claim 10 further comprising providing an escalated error alert message if a user does not acknowledge receipt of the corresponding error alert message or does not resolve the respective error state at the discrete controller within a pre-determined period of time.

12. The method as recited in claim 6, wherein each new error alert image is sortable according to the respective controller on which said new error alert image occurred.

13. A machine-readable medium that is executable on a processing machine, the medium being structured and arranged to execute the method as recited in claim 1.

14. The machine-readable medium as recited in claim 13, wherein the medium is selected from the group comprising solid-state memories, optical and magnetic disks, electrical signal representing information or electromagnetic signal representing information.

15. A system for remotely monitoring an operating status of each of a plurality of controllers, the system comprising:
a plurality of controllers, each controller adapted to generate and to locally display images of its operating status or of an operating status of a respective assay testing instrument and to transmit to a remote location in real-time or pseudo-real-time display image data representing the operating status of the respective controller;
a remote monitoring unit that is in communication with each controller, the remote monitoring unit including
a processing unit that is adapted to receive the real-time or pseudo-real-time display image data from the plurality of controllers,
a display device for displaying the transmitted display image data on the display device, and
a comparator for comparing said high resolution display image data to high resolution error alert image data corresponding to at least one error alert image stored in a database therefor,
wherein the processing unit creates an error alert message indicative of an error state at a discrete controller and causes the display device to display the error alert message when any of said high resolution display image data matches any of the high resolution error alert image data.

16. The system as recited in claim 15, wherein the processing unit is adapted to display the error alert message on the display device.

17. The system as recited in claim 15, wherein the error alert message includes at least one of a visual alert, an auditory alert, and an electronic message alert.

18. The system as recited in claim 15 further comprising:
means for creating new error alert image data that are identical or substantially identical to the discrete display image data for each of the display images that denotes an error state; and
memory for storing the new error alert image data in the database therefor.

19. The system as recited in claim 18, wherein the new error alert image data includes at least one of:
a first comparison region within the discrete display image; and
a second comparison region within the first comparison region, for performing optical character recognition of the second comparison region.

20. The system as recited in claim 15, wherein the controller communicates with the processing unit of the remote monitoring unit using remote frame buffer (RFB) protocol.

21. The system as recited in claim 15, wherein the error alert message is at least one of an alert flag image, a pop-up window message, a visual message, an auditory message, and an electronic text message.
